(19) United States
(12) Patent Application Publication
(10) Pub. No.: US 2018/0145867 A1
(43) Pub. Date: May 24, 2018

(54) APPARATUS CONTROL METHOD, DEVICE AND SYSTEM

(71) Applicant: SUZHOU TEKNECT ENGINEERING CO., LTD, Suzhou, Jiangsu (CN)

(72) Inventors: Chuangyu ZHU, Suzhou, Jiangsu (CN); Liang LIU, Suzhou, Jiangsu (CN)

(73) Assignee: SUZHOU TEKNECT ENGINEERING CO., LTD, Suzhou, Jiangsu (CN)

(21) Appl. No.: 15/574,452

(22) PCT Filed: May 19, 2015
(86) PCT No.: PCT/CN2015/079273

§ 371 Date: Nov. 15, 2017

(51) Int. Cl. H04L 29/08; H04L 29/06

(52) U.S. Cl. CPC H04L 29/08; B66F 9/063; H04L 67/12; H04L 63/08

(57) ABSTRACT

Provided are an apparatus control method, device and system. The method is applied to a controller of a system. The method comprises: wirelessly acquiring control information by the controller and from a mobile terminal or a server, and if the control information indicates that a target apparatus passes authentication, then controlling the target apparatus to be in an unlocked state, enabling an operator to operate the target apparatus, thus providing the apparatus with secure and reliable driving. User authentication information is acquired by the mobile terminal, replacing an existing vehicle-mounted card reader or vehicle-mounted display/input terminal, and thus device hardware costs are reduced, and since the mobile terminal and the controller communicate wirelessly, device wiring is simplified, and moreover the field of view of the driver is not blocked, ensuring the safety of the driver and persons and objects around the driver.

### FIELD

The present disclosure relates to the technical field of fleet management, and in particular to an apparatus control method, an apparatus control device and an apparatus control system.

### BACKGROUND

Nowadays, as a common industrial handling vehicle, a forklift truck is mainly used for loading and unloading, stacking and a short-distance transport of pallet cargo as a whole. Therefore, the forklift truck plays an important role in an enterprise logistics system and is the main force of material handling equipment, thereby being widely applied in various departments in the national economy, such as stations, ports, airports, factories and warehouses.

In practice, in order to supervise forklift trucks and operators, a fleet management system may be generally provided for an enterprise, so as to authorize a staff who operates the forklift truck or performs a daily spot check/shift check, maintenance and monitoring on the forklift truck, and cooperate with the staff to achieve these operations, etc., thereby ensuring the safe driving of the forklift truck.

According to the legal requirements of different countries, it is proposed by force that only an authorized person can operate industrial vehicles (such as the above forklift truck). In this case, an operator needs to be authenticated before operating the industrial vehicles. Therefore, in an existing fleet management system, the industrial vehicles are generally provided with an on-board card reader or an on-board display/input terminal. For the on-board card reader, authentication is achieved by swiping a card. For the on-board display/input terminal, authentication is achieved by inputting a log-in account and password. In this way, an unauthorized person is prevented from operating these industrial vehicles.

However, it is appreciated by the applicant that the on-board card reader and on-board display/input terminal may inevitably increase a hardware cost of the forklift truck, and may increase a complexity of wiring inside the forklift truck. Further, a portion of a visual field of a driver may be blocked due to the on-board display/input terminal, thereby affecting safety of the driver and pedestrians around the forklift truck, and safety of goods and equipment around the forklift truck.

### SUMMARY

In view of the above, an apparatus control method, an apparatus control device and an apparatus control system are provided according to the present disclosure, with which the following technical problems in the conventional technology are solved. Specifically, a hardware cost of the apparatus is high, a wiring of the apparatus is complex, and a portion of a visual field of a driver the apparatus is blocked due to an on-board display/input terminal, thereby affecting safety of the driver and persons around the apparatus and safety of goods and equipment around the apparatus.

In order to achieve the above objects, the following technical solutions are provided according to the present disclosure.

An apparatus control method, applied to a controller of an apparatus control system, includes:

acquiring control information in a wireless manner, where the control information includes: authentication information, a determination result indicating whether the authentication information is qualified and at least one or any combination of control instructions determined based on the determination result indicating whether the authentication information is qualified; and

controlling a target apparatus to be in an unlocked state in a case that the control information indicates that a user of the target apparatus is authenticated as qualified.

Preferably, in a case that the control information indicates that the user of the target apparatus is authenticated as qualified, the method may further include:

acquiring feedback information, where the feedback information is generated by the target apparatus in response to a first control instruction associated with spot check items in a spot check item list, or the feedback information is information inputted on a mobile terminal by an operator;

determining whether the feedback information meets a requirement; and

controlling the target apparatus to be in the unlocked state in a case that the feedback information meets the requirement.

Preferably, in a case that the control information indicates that the user of the target apparatus is authenticated as qualified, the method may further include:

acquiring a first determination result, where the first determination result is determined by a mobile terminal or a server and indicates whether feedback information meets a requirement, the feedback information is generated by the target apparatus in response to a first control instruction associated with spot check items in a spot check item list, or the feedback information is information inputted on the mobile terminal by an operator,

or the first determination result is a result inputted on the mobile terminal by the operator;

generating a second control instruction, in a case that the first determination result indicates that the feedback information meets the requirement; and

controlling the target apparatus to be in the unlocked state in response to the second control instruction.

Preferably, in a case that the control information indicates that the user of the target apparatus is authenticated as qualified, the method may further include:

acquiring a third control instruction, where the third control instruction is generated by a mobile terminal or a server in a case that a second determination result indicates that the target apparatus meets a requirement, the second determination result is determined by the mobile terminal or the server and indicates whether feedback information meets a requirement, the feedback information is generated by the target apparatus in response to a first control instruction associated with spot check items in a spot check item list, or the feedback information is information inputted on the mobile terminal by an operator,

or the third control instruction is generated by a mobile terminal or a server based on a second determination result inputted on the mobile terminal by an operator; and

controlling the target apparatus to be in the unlocked state in response to the third control instruction.

Preferably, the acquiring the control information in a wireless manner may include:

acquiring, in a wireless manner, authentication information generated and transmitted by a mobile terminal or authentication information generated by a mobile terminal and forwarded by a server;

acquiring, in a wireless manner, a determination result generated and transmitted by the mobile terminal or a determination result generated by the mobile terminal and forwarded by the server;

acquiring, in a wireless manner, a determination result generated and transmitted by the server or a determination result generated by the server and forwarded by the mobile terminal;

acquiring, in a wireless manner, a control instruction generated and transmitted by the mobile terminal or a control instruction generated by the mobile terminal and forwarded by the server; or

acquiring, in a wireless manner, a control instruction generated and transmitted by the server or a control instruction generated by the server and forwarded by the mobile terminal.

Preferably, after the acquiring, in a wireless manner, the authentication information generated and transmitted by the mobile terminal or the authentication information generated by the mobile terminal and forwarded by the server and determining that the authentication information is qualified, the method may further include:

transmitting a spot check instruction to the mobile terminal, to control the mobile terminal to output a spot check item list of the target apparatus; or

transmitting a spot check instruction to the server, where the server controls the mobile terminal to output a spot check item list of the target apparatus.

Preferably, in a case that the control information indicates that the user of the target apparatus is authenticated as qualified and before the acquiring the feedback information, a first determination result or a third control instruction, the method may further include:

transmitting a spot check item list of the target apparatus to the mobile terminal.

Preferably, in a case that an exception occurs during a spot check process performed based on the spot check items in the spot check item list, the method may further include:

acquiring image information on a spot check exception acquired by a mobile terminal and transmitting the image information on the spot check exception to a server; or

transmitting a spot check exception instruction to a mobile terminal, to control the mobile terminal to transmit the acquired image information on the spot check exception to a server.

Preferably, in a case that the control information indicates that the user of the target apparatus is authenticated as qualified, the method may further include: controlling the target apparatus to be in a standby state.

Preferably,

in a case that the spot check item for which the exception occurs during the spot check process is a preset key item, the method may further include: locking the target apparatus; and

in a case that the spot check item for which the exception occurs during the spot check process is a preset conventional item, the method may further include: determining whether the number of all of conventional items for which exception currently occurs reaches a first threshold; and locking the target apparatus in a case that the number reaches the first threshold.

Preferably, in a case that the exception occurs in the spot check process performed based on the spot check items in the spot check item list, the method may further include:

generating an exception item report based on acquired information on all of spot check exceptions; and

triggering to start a preset information interaction application, and publishing the exception item report in the information interaction application.

An apparatus control device includes:

a first acquisition module configured to acquire control information in a wireless manner, where the control information includes authentication information, a determination result indicating whether the authentication information is qualified and at least one or any combination of control instructions determined based on the determination result indicating whether the authentication information is qualified; and

a first control module configured to control a target apparatus to be in an unlocked state in a case that the control information indicates that the user of the target apparatus is authenticated as qualified.

Preferably, the apparatus control device may further include:

a second acquisition module configured to acquire feedback information in a case that the control information indicates that the user of the target apparatus is authenticated as qualified, where the feedback information is generated by the target apparatus in response to a first control instruction associated with spot check items in a spot check item list, or the feedback information is information inputted on a mobile terminal by an operator; and

a first determination module configured to determine whether the feedback information meets a requirement, and trigger the first control module if the feedback information meets the requirement.

Preferably, the apparatus control device may further include:

a third acquisition module configured to acquire a first determination result in a case that the control information indicates that the user of the target apparatus is authenticated as qualified, where the first determination result is determined by a mobile terminal or a server and indicates whether feedback information meets a requirement, the feedback information is generated by the target apparatus in response to a first control instruction associated with spot check items in a spot check item list, or the feedback information is information inputted on the mobile terminal by an operator,

or the first determination result is a result inputted on a mobile terminal by an operator; and

a first generation module configured to generate a second control instruction and trigger the first control module in a case that the first determination result indicates that the feedback information meets the requirement.

Preferably, the apparatus control device may further include:

a fourth acquisition module configured to acquire a third control instruction and trigger the first control module in response to the third control instruction;

where the third control instruction is generated by a mobile terminal or a server in a case that a second determination result indicates that the target apparatus meets a requirement, the second determination result is determined by the mobile terminal or the server and indicates whether feedback information meets a requirement, the feedback information is generated by the target apparatus in response to a first control instruction associated with spot check items in a spot check item list, or the feedback information is information inputted on the mobile terminal by an operator;

or the third control instruction is generated by a mobile terminal or a server based on a second determination result inputted on the mobile terminal by an operator.

Preferably, in a case that the first acquisition module is configured to acquire, in a wireless manner, authentication information generated and transmitted by a mobile terminal or authentication information generated by a mobile terminal and forwarded by a server, the apparatus control device may further include:

a second determination module configured to determine whether the authentication information is qualified; and

a third data transmission module configured to, in a case that the authentication information is determined as qualified by the second determination module, transmit a spot check instruction to the mobile terminal to control the mobile terminal to output a spot check item list of the target apparatus, or transmit a spot check instruction to the server, where the server controls the mobile terminal to output a spot check item list of the target apparatus.

Preferably, the apparatus control device may further include:

a fourth data transmission module configured to transmit a spot check item list of the target apparatus to the mobile terminal, in a case that the control information indicates that the user of the target apparatus is authenticated as qualified and before the feedback information, a first determination result or a third control instruction is acquired.

Preferably, the apparatus control device may further include:

a fifth acquisition module configured to, in a case that an exception occurs during a spot check process performed based on the spot check items in the spot check item list, acquire image information on the spot check exception acquired by a mobile terminal and transmit the image information on the spot check exception to a server, or transmit a spot check exception instruction to the mobile terminal to control the mobile terminal to transmit the acquired image information on the spot check exception to a server.

Preferably, the apparatus control device may further include:

a second generation module configured to generate an exception item report based on the acquired information on all of spot check exceptions, in a case that the exception occurs in the spot check process performed based on the spot check items in the spot check item list; and

a first interaction module configured to trigger to start a preset information interaction application and publish the exception item report in the information interaction application.

An apparatus control system is provided, which includes a server, at least one controller and at least one mobile terminal, where

the mobile terminal is configured to acquire authentication information; and

the controller includes the above apparatus control device.

Preferably, the apparatus control system may further include:

an image acquisition device provided on an apparatus and configured to acquire current environment information of the apparatus.

An apparatus control system is provided, which includes a server and at least one mobile terminal, where

the mobile terminal is connected to the server in a wireless manner, and is configured to acquire identification information of a target apparatus and transmit the identification information to the server; and

the server is configured to transmit, after receiving the identification information, a spot check item list of the target apparatus to the mobile terminal for display.

As can be seen, as compared with the conventional technologies, with the apparatus control method, apparatus control device and apparatus control system according to the present disclosure, a controller can acquire control information in a wireless manner, and controls a target apparatus to be in an unlocked state only in a case that the control information indicates that the user of the target apparatus is authenticated as qualified, thereby preventing an unauthorized user from illegally operating the apparatus. The control information includes authentication information transmitted by a mobile terminal or a server, a determination result determined by the mobile terminal or the server and indicating whether the authentication information is qualified, and at least one or any combination of control instructions directly determined by the mobile terminal or the server based on the determination result indicating whether the authentication information is qualified. Therefore, according to the present disclosure, authentication information of users is acquired by the mobile terminal, instead of the existing on-board card reader or on-board display/input terminal, thereby reducing a hardware cost of the apparatus. Besides, the wiring inside the apparatus is simplified, since the mobile terminal is connected to the controller in a wireless manner and can directly communicate with the server in a wireless manner. Moreover, a visual field of a driver of the apparatus is not blocked, thereby ensuring the safety of the driver and persons around the apparatus and the safety of the goods and equipment around the apparatus.

### BRIEF DESCRIPTION OF THE DRAWINGS

In order to more clearly illustrate technical solutions according to the embodiments of the present disclosure or according to the conventional technology, the drawings to be used in the description of the embodiments or the conventional technology are briefly described below. Apparently, the drawings in the following description only describe some embodiments of the present disclosure, and other drawings may be obtained by those skilled in the art according to the drawings provided herein without any creative work.

FIG. 1 is a schematic flowchart of an apparatus control method according to an embodiment of the present disclosure;

FIG. 2 is a schematic flowchart of another apparatus control method according to an embodiment of the present disclosure;

FIG. 3 is a schematic flowchart of yet another apparatus control method according to an embodiment of the present disclosure;

FIG. 4 is a schematic structural diagram of an apparatus control device according to an embodiment of the present disclosure;

FIG. 5 is a schematic structural diagram of another apparatus control device according to an embodiment of the present disclosure;

FIG. 6 is a schematic structural diagram of an apparatus control system according to an embodiment of the present disclosure; and

FIG. 7 is a schematic structural diagram of another apparatus control system according to an embodiment of the present disclosure.

### DETAILED DESCRIPTION OF EMBODIMENTS

The technical solutions according to the embodiments of the present disclosure are described clearly and completely in conjunction with the drawings in the embodiments of the present disclosure hereinafter. It is apparent that the described embodiments are only a few rather than all of the embodiments of the present disclosure. Any other embodiments obtained based on the embodiments of the present disclosure by those skilled in the art without any creative work fall within the scope of protection of the present disclosure.

An apparatus control method, an apparatus control device and an apparatus control system are provided according to the present application, a controller can acquire control information in a wireless manner, and control a target apparatus to be in an unlocked state only in a case that the control information indicates that the user of the target apparatus is authenticated as qualified, thereby preventing an unauthorized user from illegally operating the apparatus. The control information includes authentication information transmitted by a mobile terminal or a server, a determination result determined by the mobile terminal or the server and indicating whether the authentication information is qualified, and at least one or any combination of control instructions directly determined by the mobile terminal or the server based on the determination result indicating whether the authentication information is qualified. Therefore, according to the present disclosure, authentication information of users is acquired by the mobile terminal, instead of the existing on-board card reader or on-board display/input terminal, thereby reducing a hardware cost of the apparatus. Besides, the wiring inside the apparatus is simplified, since the mobile terminal is connected to the controller in a wireless manner and can directly communicate with the server in a wireless manner. Moreover, a visual field of a driver of the apparatus is not blocked, thereby ensuring the safety of the driver and persons around the apparatus and the safety of the goods and equipment around the apparatus.

The apparatus controlled by the above method, device and system according to the present disclosure may be a mobile apparatus or an operational industrial apparatus, such as a forklift truck, an in-plant transport vehicle, a climbing maintenance vehicle and a sweeping machine, which is not limited herein.

The objects, features and advantages of the present disclosure will become more apparent and easier to be understood from the following detail description of embodiments of the present disclosure made with reference to the drawings.

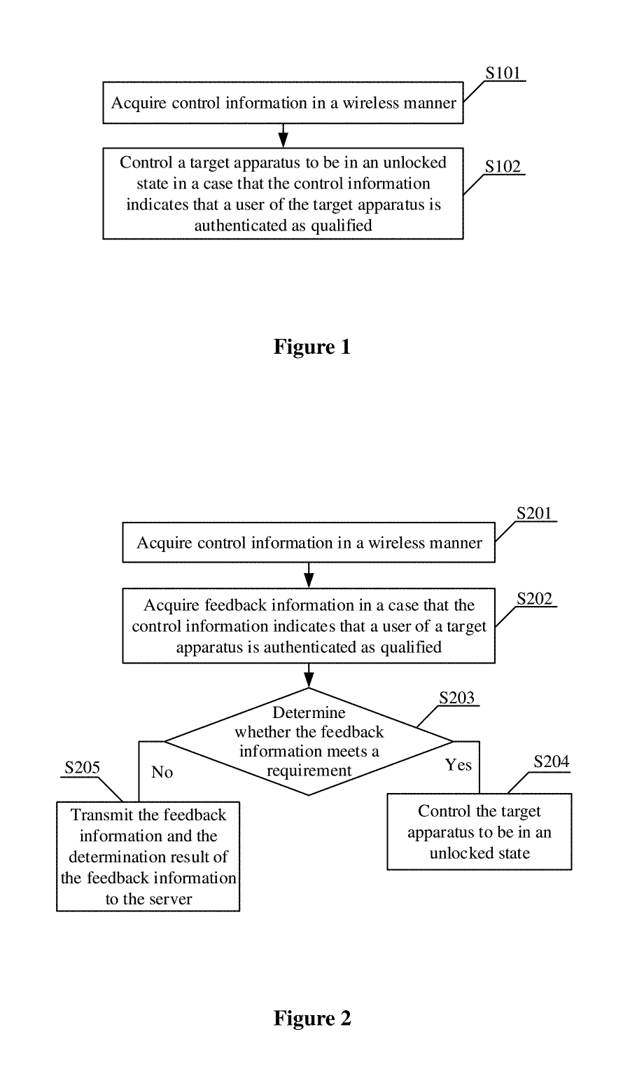

FIG. 1 is a schematic flowchart of an apparatus control method according to an embodiment of the present disclosure.

Based on the above analysis, the apparatus control method according to the present disclosure may include steps S101 to S102.

In step S101, control information is acquired in a wireless manner.

In the embodiment, the control information includes authentication information, a determination result indicating whether the authentication information is qualified and at least one or any combination of control instructions determined based on the determination result indicating whether the authentication information is qualified, which is not limited herein.

The authentication information may be directly (such as WIFI, Zigbee, Near Field Communication (NFC) or Bluetooth, which is not limited) transmitted to a controller by a mobile terminal in a wireless manner; alternatively, the authentication information may be transmitted to a server by the mobile terminal and then is forwarded by the server, which is not limited herein.

In addition, the authentication information may be an account and/or a password, pattern information, fingerprint information, pupil information, facial information and the like, which falls within the scope of protection of the present disclosure, as long as it is not determined by those skilled in the art with creative work.

In practice, an apparatus control application may be installed on a mobile terminal. In a case that an operator needs to operate an industrial apparatus (such as a forklift truck, an in-plant transport vehicle, a climbing maintenance vehicle and a sweeping machine), the operator may directly open a login interface of the apparatus control application on the mobile terminal, login the application in a way of inputting an account and a password, inputting a preset unlocking pattern and the like, and the login mode for the apparatus control application is not limited herein.

Practically, the operator may open a preset apparatus control webpage with a browser in the mobile terminal, that is, starting the apparatus control application based on the browser. In this case, the operator logins the apparatus control application by inputting the account and password, to control the apparatus.

The mobile terminal may be a mobile phone, a laptop computer, a tablet computer, a Personal Digital Assistant (PDA) and the like, and is not limited herein as long as the mobile terminal has a wireless communication function.

Optionally, in the actual application of the present disclosure, step S101 may include:

acquiring, in a wireless manner, authentication information generated and transmitted by a mobile terminal or authentication information generated by a mobile terminal and forwarded by a server;

acquiring, in a wireless manner, a determination result generated and transmitted by the mobile terminal or a determination result generated by the mobile terminal and forwarded by the server;

acquiring, in a wireless manner, a determination result generated and transmitted by the server or a determination result generated by the server and forwarded by the mobile terminal;

acquiring, in a wireless manner, a control instruction generated and transmitted by the mobile terminal or a control instruction generated by the mobile terminal and forwarded by the server; or

acquiring, in a wireless manner, a control instruction generated and transmitted by the server or a control instruction generated by the server and forwarded by the mobile terminal.

As can be seen, the way in which the controller acquires the control information is not unique and the acquired control information contains various contents, which can be selected according to the actual requirements and is not limited herein.

The mobile terminal can be connected to the server in a wireless mode such as Wideband Code Division Multiple Access (WCDMA), Global System for Mobile Communication (GSM) and 3G/4G thereby achieving wireless communication between the mobile terminal and the server. Wireless transmission between the server and the controller belongs to the conventional technology, and is not described in detail herein.

In addition, the content of the control instruction may be determined based on a current state of the apparatus and the determination result indicating whether the authentication information is qualified. The control instruction may be a power-on standby instruction, a standby instruction, an operation instruction and the like, and is not limited herein.

In step S102, in a case that the control information indicates that a user of a target apparatus is authenticated as qualified, the target apparatus is controlled to be in an unlocked state.

Optionally, in a case that the control information is the authentication information transmitted by the server or the mobile terminal, step S102 may include: determining whether the authentication information is qualified, generating a corresponding control instruction to control the selected target apparatus to be in an unlocked state if the authentication information is qualified, so that the operator can operate the target apparatus; otherwise, it is indicated that the authentication information is illegal information, that is, the operator inputting the authentication information is unauthorized to operate the target apparatus, thereby preventing the unauthorized user from illegally operating the target apparatus.

In summary, in the embodiment, authentication information of users is acquired by the mobile terminal, instead of the existing on-board card reader or on-board display/input terminal, thereby reducing the hardware cost of the apparatus. Besides, the wiring inside the apparatus is simplified, since the mobile terminal is connected to the controller in a wireless manner. Moreover, the visual field of a driver of the apparatus is not blocked, thereby ensuring the safety of the driver and persons around the apparatus and the safety of the goods and equipment around the apparatus.

Preferably, in the actual application of the present disclosure, in order to further improve the reliability of operation safety of a mobile apparatus or a moveable industrial apparatus, a daily spot check may be performed on the target apparatus in a case that the control information indicates that the user of the target apparatus is authenticated as qualified. Only in a case that a spot check result meets a preset spot check standard, the operator can drive the target apparatus. Specifically, the present disclosure may be described in detail with the following embodiments, but is not limited to these embodiments. The following embodiments may be appropriately modified by those skilled in the art in conjunction with the conventional technology or the conventional technical means in accordance with the actual needs, within the core concept of the present disclosure. The modified embodiments all fall within the scope of protection of the present disclosure, and are not described in detail herein.

FIG. 2 is a schematic flowchart of another apparatus control method according to an embodiment of the present disclosure. The method may include steps S201 to S205.

In step S201, control information is acquired in a wireless manner.

The control information may include: authentication information, a determination result indicating whether the authentication information is qualified and at least one or any combination of control instructions determined based on the determination result indicating whether the authentication information is qualified.

In step S202, in a case that the control information indicates that a user of a target apparatus is authenticated as qualified, feedback information is acquired.

The feedback information is generated by the target apparatus in response to a first control instruction associated with spot check items in a spot check item list. The spot check item list may be pre-stored and transmitted to a mobile terminal by a controller, may be stored by the mobile terminal, or may be transmitted to the mobile terminal by a server, which is not limited herein.

In an actual application of the embodiment, the mobile terminal may display the spot check item list of the target apparatus. In this case, if an operator is authenticated as qualified, the operator may select a spot check item from the spot check item list according to actual requirements, and perform a spot check on the target apparatus based on the selected spot check item. In an actual spot check, for each spot check item, the operator may transmit a first control instruction to the controller of the target apparatus with the mobile terminal directly or via the server, thereby achieving the spot check of the target apparatus. In the spot check process, the controller or the mobile terminal may obtain corresponding feedback information, thereby determining whether the target apparatus meets the spot check standard based on the feedback information.

Optionally, in an actual spot check process, a spot check may be performed on the target apparatus by the operator based on a content of a spot check item presented on the mobile terminal, and current state information on components of the target apparatus being spot-checked, i.e., feedback information, is inputted to the mobile terminal, that is, the feedback information may be information inputted on the mobile terminal by the operator. In this case, the mobile terminal may determine whether the target apparatus meets the spot check standard, or the mobile terminal may transmit the feedback information to the controller or the server, so that the controller or the server determines whether the target apparatus meets the spot check standard. Practically, after determining a spot check result of the target apparatus or an operation to be executed by the target apparatus, the operator may inform the controller of the spot check result or the operation via the mobile terminal, thereby completing the subsequent operation. It should be noted that, the spot check for the apparatus belongs to conventional technologies, and is not described in detail herein.

It can be seen from the above analysis that, the feedback information acquired in step S202 may be feedback information generated and transmitted by the target apparatus in response to the first control instruction, which is directly acquired by the controller, may be feedback information generated by the target apparatus in response to the first control instruction, which is transmitted by the mobile terminal and acquired by the controller, or may be feedback information generated by the target apparatus in response to the first control instruction, which is forwarded by the server and acquired by the controller. Practically, the feedback information acquired in step S202 may also be information outputted by the mobile terminal or information outputted by the mobile terminal and forwarded by the server, which is directly received by the controller, and the feedback information is not limited herein.

Preferably, in a case that the control information acquired by the above controller is the determination result indicating whether the authentication information is qualified and/or the control instruction obtained based on the determination result indicating whether the authentication information is qualified and if both the determination result and the control instruction are directly transmitted by the mobile terminal or forwarded by the server, in an actual application, the mobile terminal may directly display the spot check item list of the target apparatus or the server may directly transmit the spot check item list of the target apparatus to the mobile terminal in a case that the authentication information is determined as qualified by the mobile terminal; if both the determination result and the control instruction are obtained and transmitted by the server, the server may transmit the spot check item list of the target apparatus to the mobile terminal in a case of determining the authentication information as qualified.

Practically, in a case that the control information is the authentication information generated and transmitted by the mobile terminal or the authentication information generated by the mobile terminal and forwarded by the server, which is acquired by the controller in a wireless manner, and if the authentication information is determined as qualified by the controller, a spot check instruction may be transmitted to the mobile terminal, to control the mobile terminal to output the spot check item list of the target apparatus; or a spot check instruction may be transmitted to the server, so that the server controls the mobile terminal to output the spot check item list of the target apparatus. The way for outputting the spot check instruction is not limited herein, and any solution determined by those skilled in the art without any creative work falls within the scope of protection of the present disclosure.

In the present disclosure, content of the spot check item list displayed on the mobile terminal may be editable. Therefore, a manager may define the content for an actual application, and may group the spot check items based on importance into key items or conventional items for example, so that the operator can perform a spot check more targetedly.

In step S203, it is determined whether the feedback information meets a requirement. If the feedback information meets the requirement, step S204 is performed; or if the feedback information does not meet the requirement, step S205 is performed.

In an actual application of the present embodiment, spot check standards may be set for different types of apparatuses and different spot check items of the apparatuses. If a spot check result indicates that the spot check standard is met, it is allowed to operate the apparatus; otherwise, it is not allowed to operate the apparatus, that is, the apparatus is in an unavailable state.

In step S204, the target apparatus is controlled to be in an unlocked state.

In step S205, the feedback information and the determination result of the feedback information are transmitted to the server.

Based on the above analysis, in the embodiment, authentication information of users is acquired by the mobile terminal, instead of the existing on-board card reader or on-board display/input terminal, thereby reducing the hardware cost of the apparatus. Before the target apparatus is operated, a spot check is performed on the target apparatus by the mobile terminal. In this way, the target apparatus can be unlocked only in a case that the acquired feedback information meets the requirement, thereby improving safety and reliability in driving the apparatus. Besides, the wiring inside the apparatus is simplified, since the mobile terminal is connected to the controller in a wireless manner. Moreover, the visual field of a driver of the apparatus is not blocked, thereby ensuring the safety of the driver and persons around the apparatus and the safety of the goods and equipment around the apparatus.

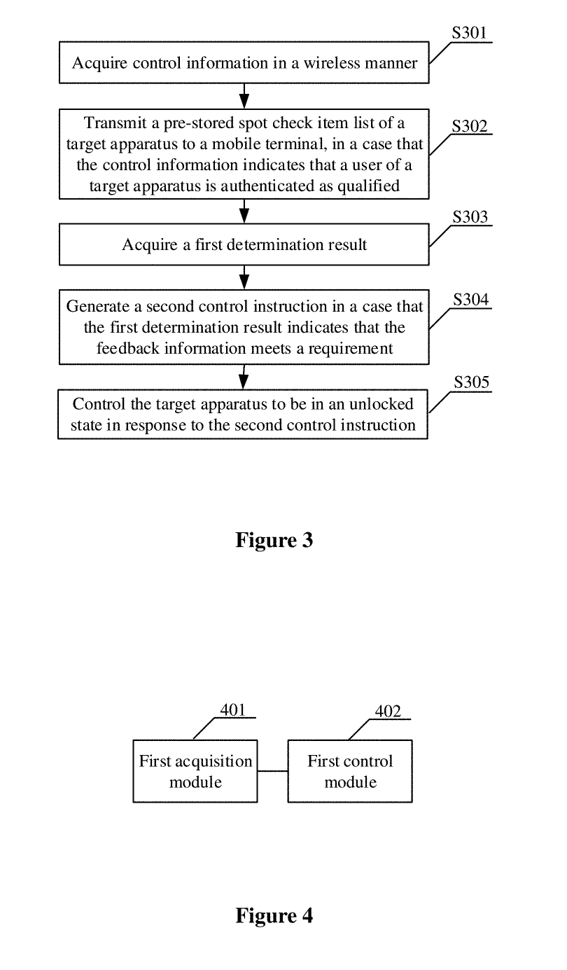

FIG. 3 is a schematic flowchart of another apparatus control method according to an embodiment of the present disclosure. The method may include steps S301 to S305.

In step S301, control information is acquired in a wireless manner.

The control information may include: authentication information, a determination result indicating whether the authentication information is qualified and at least one or any combination of control instructions determined based on the determination result indicating whether the authentication information is qualified.

In step S302, in a case that the control information indicates that the user of a target apparatus is authenticated as qualified, a pre-stored spot check item list of the target apparatus is transmitted to the mobile terminal.

In an actual application, a daily spot check for an industrial apparatus of different types and different models can be completed only by professionals. In this case, in order to avoid an illegal operation by non-professionals, which results in inaccuracy spot check results and further affects personal safety of an operator driving a target apparatus, in the embodiment, authority management may be performed on operators, that is, an operator is authenticated before the operator performs operations of daily spot check, driving and the like on the target apparatus. The specific authentication process can be seen in the description of corresponding parts of the above embodiment, and is not described in detail herein.

In a case that the operator is to be authorized to operate, the type of an apparatus that the operator is allowed to operate may be limited, or certain apparatuses may be directly specified for some operators to operate. Besides, an operation duration may be further defined for the operator, so that the operator cannot operate the apparatus continuously when the operation duration expires.

Practically, besides, a system may further authorize different types of users, such as administrators, apparatus operators, maintenance technicians and the like, and corresponding authorities may be set based on the skills of these users. For example, the apparatus operator may be only authorized to operate the apparatus, and not allowed to access contents of a server, which is not enumerated herein. All solutions determined by those skilled in the art without any creative work fall within the scope of protection of the present disclosure.

Optionally, in an actual application, in a case that the determination result indicating whether the authentication information is qualified indicates that the authentication information is qualified, that is, the operator inputting the authentication information is a legal user, or in a case that the control instruction determined based on the determination result indicating whether the authentication information is qualified is a power-on standby instruction or a standby instruction, the target apparatus may be controlled to be in a standby state. That is to say, before the above operation, in a case that the controller is in a normally-off state and once the determination result indicating that the authentication information is qualified or the standby instruction is received, the controller is powered on, that is, the target apparatus is controlled to be in the power-on standby state; or in a case that the controller is in a normally-on state, the target apparatus may be directly controlled to be in the standby state.

It should be noted that, in order to improve safety and reliability in operating the apparatus, the target apparatus in the standby state is still inoperable.

In an actual application of the above embodiment, in a case that the authentication information is determined as qualified, all of apparatuses which are in an available state and are operable for the operator may be directly displayed on the mobile terminal. Then, the operator may select a required apparatus from the displayed apparatuses as a target apparatus. Practically, information on the apparatus in the available state may be transmitted to the mobile terminal by the server, which is not limited herein.

The apparatus in an unavailable state may specifically be an apparatus in a fault state or a maintenance state, an apparatus being used and the like. All apparatuses other than the apparatus in the unavailable state are the apparatuses in the available state.

Optionally, while transmitting a list of the apparatuses that an account is authorized to operate to the mobile terminal, the server may record personal information of an operator logging with the account and various kinds of real-time information of the apparatuses. The real-time information may be acquired from the controller of the target apparatus directly or acquired from the controller via the mobile terminal, which is not limited herein.

After a target apparatus to be operated is determined by the operator, the mobile terminal may transmit information on the selected target apparatus (such as a type and a model of the apparatus) to the server or the controller, and the server or the controller of the target apparatus may transmit a pre-stored spot check item list to the mobile terminal for display. Practically, the spot check item list of the target apparatus may be acquired in other ways. One may refer to the description of corresponding parts of the above embodiment and it is not described herein.

As another embodiment of the present disclosure, it can be seen in conjunction with the above embodiments that, the spot check item list of the target apparatus may be acquired in various ways. Therefore, the above step S302 may further include: in a case that the control information indicates that the user of the target apparatus is authenticated as qualified, transmitting a spot check instruction to the mobile terminal, to control the mobile terminal to output the spot check item list of the target apparatus; or transmitting a spot check instruction to the server, so that the server controls the mobile terminal to output the spot check item list of the target apparatus.

Besides, in a case that the determination result indicating that the authentication information is qualified is determined by the mobile terminal itself rather than being informed by the controller or the server, the mobile terminal directly outputs the spot check item list of the target apparatus. Similarly, in a case that the determination result indicating that the authentication information is qualified is determined by the server itself rather than being informed by the controller or the mobile terminal, the server actively transmits the spot check item list of the target apparatus to the mobile terminal for display in step S303. Therefore, the way for displaying the spot check item list of the target apparatus on the mobile terminal is not limited herein. The mode recorded in step S303 is only taken as an example for describing the present disclosure, and is not intended to limit the present disclosure.

In step S303, a first determination result is acquired.

The first determination result may be determined by the mobile terminal or the server and indicate whether feedback information meets a requirement, that is, a spot check result obtained by performing a spot check on the target apparatus. The feedback information may be generated by the target apparatus in response to a first control instruction associated with spot check items in the spot check item list, or the feedback information may be information inputted on the mobile terminal by the operator. For a specific process, one may refer to the description of the corresponding parts of the above embodiment, and it is not described in detail herein. It can be seen from the above analysis that, during a spot check process for the target apparatus, a spot check list may be generated with acquired spot check information (such as a type and a model of the target apparatus, a spot check duration, a spot check item and a spot check operator) in a preset form, and is transmitted to the server for storage. Thus, a manager can know a working condition of the operator and a spot check condition of the apparatus. Moreover, the preset form may be determined according to actual needs. For example, the preset form may include a spot check apparatus, a spot check operator, a spot check item, a spot check duration and the like, which is not limited herein.

The above spot check information may be acquired directly by the controller, may be acquired directly by the mobile terminal, or may be acquired directly by the server. Therefore, the first determination result here may be a result obtained by the mobile terminal or the server by determining whether the acquired spot check information meets a spot check standard.

As another embodiment of the present disclosure, the first determination result may be a result inputted on the mobile terminal by the operator. That is to say, in a case that the spot check is performed on the target apparatus and the spot check result is qualified, the operator may click an icon or button representing “yes” on a display interface for a current spot check item on the mobile terminal, to inform the controller or the server of the qualified spot check result, and the specific way is not limited herein.

In step S304, in a case that the first determination result indicates that the above feedback information meets the requirement, a second control instruction is generated.

In other words, in a case that the spot check result of the target apparatus meets the corresponding spot check standard, a corresponding second control instruction such as an unlocking instruction is generated based on information, such as a current state of the target apparatus.

In step S305, the target apparatus is controlled to be in an unlocked state in response to the second control instruction.

In an actual application, only in a case that the target apparatus is controlled to be in the unlocked state, the operator can operate the target apparatus.

Optionally, in an actual application, for the spot check item on which a spot check fails, an exception item report similar to the above spot check list may be generated separately. In this case, the manager can intuitively and quickly view information on all of spot check exceptions and processes the exceptions accordingly.

In a case that the mobile terminal includes an image acquisition component (such as a camera) and if an exception occurs during a spot check process, the operator may choose or may be required to acquire an image with the image acquisition component of the mobile terminal, i.e., taking photos, shooting videos or the like. The image may be transmitted to the server directly or via an on-board controller. In this case, a background management apparatus can acquire image information on the exception from the server, and determine problems quickly and conveniently in conjunction with information on other spot check exceptions, thereby improving a troubleshooting efficiency.

As can be seen that, in a case that the exception occurs during the spot check process, the controller may acquire the image information on the spot check exception acquired by the mobile terminal and transmit the image information on the spot check exception to the server. Alternatively, a spot check exception instruction may be transmitted to the mobile terminal to control the mobile terminal to transmit the acquired image information on the spot check exception to the server, which is not limited herein.

As another embodiment of the present disclosure, based on the above embodiments, in order to share the information on the spot checks obtained by the system among authorized persons within an enterprise and authorized persons in an external associated party and improve the enterprise management efficiency, an information interaction application may be installed in the mobile terminal, such as FACKBOOK, WeChat, QQ or other dedicated applications, as long as the application can achieve information sharing or communication. Practically, the information sharing and communication may also be achieved with an information interaction application in a browser, which is not limited herein.

Based on this, in an actual application of the embodiment, in a case that an exception occurs during a spot check process, an exception item report may be generated based on acquired information on all of spot check exceptions, thereby triggering to start the information interaction application and publishing the exception item report in the information interaction application. In this way, the user capable of logging the information interaction application can analyze or discuss a content of the exception item report, thereby providing a corresponding solution quickly and effectively.

As another embodiment of the present disclosure, in a case that a spot check item for which an exception occurs in a spot check process is a preset key item, the apparatus may be locked immediately, and the event of locking the apparatus and information on the spot check exception are transmitted to the server.

In a case that a spot check item for which an exception occurs in a spot check process is determined as a preset conventional item, it may be determined whether the number of all of conventional items for which spot check exceptions occur currently reaches a first threshold. If the number does not reach the first threshold, the spot check may be continued and all of acquired spot check information is transmitted to the server. If the number reaches the first threshold, the apparatus is locked immediately, and the event of locking the apparatus and information on the spot check exceptions are transmitted to the server.

As can be seen that, in a case that the above two conditions for locking the apparatus are met, it is unnecessary to complete all of the spot check items of the target apparatus, that is, the target apparatus may be determined as an unavailable apparatus once either of the above two conditions is met. In this case, the target apparatus needs an overhaul by a maintenance person, and it is unnecessary to perform the remaining spot check items, thereby improving the spot check efficiency.

Besides, according to actual needs, a spot check duration may be further set for the spot check item, such as a shortest spot check duration and a longest spot check duration. In a case that a certain spot check item is performed on the target apparatus, the operator cannot perform a next spot check item if a spot check duration for the certain spot check item does not reach the shortest spot check duration; and if the spot check duration for the certain spot check item exceeds the longest spot check duration, the spot check process is recorded and reported, as an assessment criteria of the operator.

Besides, all of the apparatuses may be configured on the server side. For example, only one spot check is to be performed on each apparatus every day, that is, no matter which operator has carried out a spot check on a certain apparatus, other authorized operators can directly operate the apparatus without performing the spot check on the apparatus again on this day, thereby avoiding repeatedly performing the spot check. Practically, in order to improve the safety in operating an apparatus, in a same day, different operators may respectively perform spot checks on a same apparatus before operating the apparatus, to determine whether the apparatus meets an operation requirement at present.

It should be noted that, during a process of performing the spot check on the apparatus, certain spot check items can only be completed by operating the apparatus, such as braking, accelerating or steering. Therefore, when the certain spot check items are to be performed, the target apparatus may be unlocked for a short duration to allow the operator to operate and check. The unlocked duration is a spot check duration required for these special spot check items, i.e., a second threshold, which is determined based on experience, and the numeric value of the unlocked duration is not limited herein. In an actual application, once an actual unlocked duration reaches the second threshold, the apparatus is locked.

In summary, in the actual applications of the present embodiment, the controller acquires the control information in a wireless manner and displays the spot check item list of the target apparatus on the mobile terminal in a case that the control information indicates that the user of the target apparatus is authenticated as qualified. In this case, the operator performs a spot check on the target apparatus based on the spot check items in the spot check item list. The selected target apparatus is controlled to be in an unlocked state only in a case that feedback information acquired during the spot check process meets a requirement, thereby improving the safety and reliability in driving the target apparatus. Therefore, according to the present disclosure, authentication information of users is acquired by the mobile terminal, instead of the existing on-board card reader or on-board display/input terminal, thereby reducing the hardware cost of the apparatus. Besides, the wiring inside the apparatus is simplified and interference to components other than the controller in the apparatus is reduced, since the mobile terminal is connected to the controller in a wireless manner. Moreover, the visual field of a driver of the apparatus is not blocked, thereby ensuring the safety of the driver and persons around the apparatus and the safety of the goods and equipment around the apparatus.

Optionally, corresponding to the above embodiment, after step S302, the controller may further directly acquire a third control instruction and control the target apparatus to be in an unlocked state in response to the third control instruction.

In a case that a second determination result indicates that the target apparatus meets a spot check requirement, the third control instruction may be generated by the mobile terminal or the server based on the second determination result. The second determination result may be determined by the mobile terminal or the server and indicates whether feedback information meets a requirement. The feedback information is generated by the target apparatus in response to a first control instruction associated with spot check items in a spot check item list, or the feedback information is information inputted on the mobile terminal by an operator. Besides, the third control instruction may also be generated by the mobile terminal or the server based on the second determination result inputted on the mobile terminal by the operator, which is not limited herein. It can be seen in conjunction with the above analysis that, the effect of the above embodiment can also be achieved with the optional embodiment, and the effect is not described herein.

In the above embodiments, it should be noted that, during an actual control process of the apparatus, in order to maintain the safety and reliability in operating the apparatus, a collision detection, a maintenance interval and operation efficiency detection and the like may be included, in addition to the control process described above in the present disclosure.

For the collision detection of the apparatus, a collision sensor may be arranged at a proper position of the apparatus and is connected to the controller, and the position where the collision sensor is arranged is not limited herein. In an actual application, the collision sensor may transmit a detected collision signal to the controller, and the controller transmits the collision signal and information on the collision signal (such as a collision forklift truck, an operator, a collision level, a collision location and an instant photo or video around the collision location) to the server in a wireless manner or via the mobile terminal. In this way, a background management apparatus acquires information on all collisions from the server and performs management based on the information.

In the embodiment, a specific detection of the collision sensor and a connection relationship between the collision sensor and the controller both belong to the conventional technology, which are not described in detail herein.

Optionally, in an actual application, the surrounding situations of a forklift truck may be captured continuously with an image acquisition device such as an on-board shooting system provided on a mobile apparatus or an operable industrial apparatus. In a case that a collision event occurs, videos or a few photos may be acquired as needed within a certain duration before and after the collision, so that the background management apparatus can restore the collision scene and determine a person responsible for the collision event.

In the present disclosure, the collision location may be determined with wireless technologies including Global Positioning System (GPS), a carrier-free communication technology such as Ultra Wideband (UWB), WIFI and the like. Alternatively, the collision location may be determined with sensors arranged at different positions, by means of Radio Frequency Identification (RFID), infrared or induction coils.

Optionally, in a case that it is determined that an apparatus collides, the controller may directly activate an audible and visual alarm, while locking the apparatus immediately or after a certain period of time, that is, controlling the apparatus to stop working. The apparatus can be unlocked only in a case that a user with a special authority uses his/her identification card or inputs his/her private password. The way in which the apparatus is unlocked is not limited herein.

It should be noted that, parameters of the above on-board collision sensor can be reconfigured on the server side or on an apparatus terminal. These parameters may include a collision threshold, analysis and determination of collision waveforms, and the like.

As another embodiment of the present disclosure, in addition to the above collision sensors and position sensors, the controller may be provided with other different sensors for acquiring data for other requirements, such as a requirement that an enterprise user needs to know working time of a forklift truck for different purposes. In this case, the user may choose data appropriate for himself/herself as a basis for apparatus management. In addition, a corresponding report is generated based on system default requirements or user-defined requirements, such as a statistical report of staff working efficiency or apparatus utilization, based on which the apparatus is maintained and the staff is assessed.

Reference is made to FIG. 4, which is a schematic structural diagram of an apparatus control device according to an embodiment of the present disclosure. The device may include a first acquisition module 401 and a first control module 402.

The first acquisition module 401 is configured to acquire control information in a wireless manner. The control information may be authentication information, a determination result indicating whether the authentication information is qualified, or control instructions determined based on the determination result indicating whether the authentication information is qualified.

The authentication information may be transmitted to a controller by a mobile terminal in a wireless way (such as WIFI, Zigbee, Near Field Communication (NFC) or Bluetooth, which is not limited herein). Alternatively, the authentication information may be transmitted to a server by the mobile terminal and then forwarded by the server; which is not limited herein.

The first control module 402 is configured to control a target apparatus to be in an unlocked state in a case that the control information indicates that the user of the target apparatus is authenticated as qualified.

Optionally, in a case that the first acquisition module 401 is configured to acquire, in a wireless manner, the authentication information generated and transmitted by the mobile terminal or the authentication information generated by the mobile terminal and forwarded by the server, the apparatus control device may further include a second determination module and a third data transmission module.

The second determination module is configured to determine whether the authentication information is qualified.

The third data transmission module is configured to transmit a spot check instruction to the mobile terminal to control the mobile terminal to output a spot check item list of the target apparatus or transmit a spot check instruction to a server so that the server controls the mobile terminal to output a spot check item list of the target apparatus, in a case that the authentication information is determined as qualified by the second determination module.

Practically, the first control module may be directly triggered to control the target apparatus to be in the unlocked state, in a case that the authentication information is determined as qualified by the second determination module.

It can be seen from the above embodiments that, in the embodiment, authentication information of users is acquired by the mobile terminal, instead of the existing on-board card reader or on-board display/input terminal, thereby reducing the hardware cost of the apparatus. Besides, the wiring inside the apparatus is simplified, since the mobile terminal is connected to the controller in a wireless manner. Moreover, the visual field of a driver of the apparatus is not blocked, thereby ensuring the safety of the driver and persons around the apparatus and the safety of the goods and equipment around the apparatus.

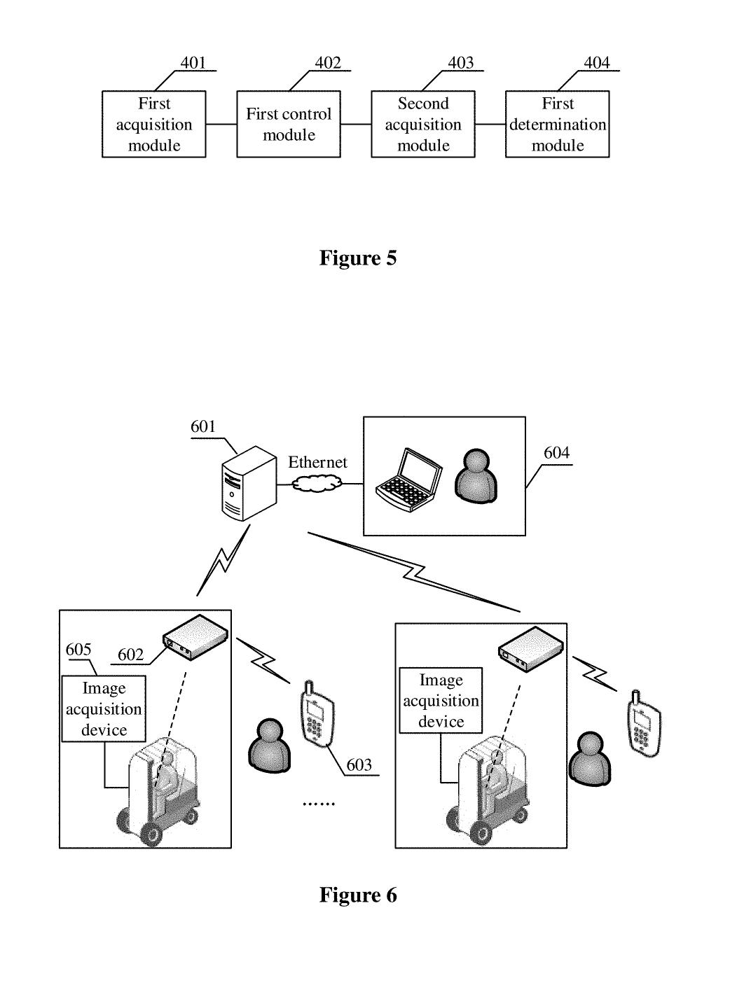

Optionally, based on the above embodiments, referring to FIG. 5, the apparatus control device may further include a second acquisition module 403 and a first determination module 404.

The second acquisition module 403 is configured to acquire feedback information in a case that the control information indicates that the user of the target apparatus is authenticated as qualified.

The feedback information may be generated by the target apparatus in response to a first control instruction associated with the spot check items in the spot check item list, or the feedback information may be information inputted on the mobile terminal by the operator. The spot check item list may be pre-stored and transmitted to the mobile terminal by the controller, may be stored and outputted directly by the mobile terminal, or may be transmitted to the mobile terminal by a server, which is not limited herein.

In addition, the feedback information may be feedback information generated and transmitted by the target apparatus in response to the first control instruction, which is directly acquired by the controller, may be feedback information generated by the target apparatus in response to the first control instruction, which is forwarded by the mobile terminal and acquired by the controller, or may be feedback information generated by the target apparatus in response to the first control instruction, which is forwarded by the server and acquired by the controller, and specific forms of the feedback information are not limited herein. The specific implementation solutions can be determined according to actual needs, and are not enumerated herein.

It can be seen from the above that, in a case that the control information indicates that the user of the target apparatus is authenticated as qualified, the spot check item list of the target apparatus may be transmitted to the mobile terminal via a fourth data transmission module before the feedback information is acquired.

It should be noted that the fourth data transmission module may be arranged in the server, and the server may actively transmit the spot check item list of the target apparatus to the mobile terminal. Practically, the mobile terminal may actively output the spot check item list of the target apparatus. For the specific process, one may refer to the description of corresponding parts of the above embodiments and the process is not described herein.

The first determination module 404 is configured to determine whether the feedback information meets a requirement, and trigger the first control module 402 if the feedback information meets the requirement.

If the feedback information does not meet the requirement, the feedback information and the determination result of the feedback information may be transmitted to the server directly or via the mobile terminal.

As another embodiment of the present disclosure, based on the embodiment shown in FIG. 4, the apparatus control device may further include a first data transmission module, a third acquisition module and a first generation module.

The first data transmission module is configured to transmit a pre-stored spot check item list of the target apparatus to the mobile terminal in a case that the control information indicates that the user of the target apparatus is authenticated as qualified.

It can be seen from the above analysis that, the first data transmission module may be the same as the above fourth data transmission module, that is, the output way for the spot check item list of the target apparatus is not limited to the above way. For the output way, one may refer to the description of corresponding parts of the method embodiment described above, and the output way is not described herein.

The third acquisition module is configured to acquire a first determination result. The first determination result is determined by a mobile terminal or a server and indicates whether feedback information meets a requirement. The feedback information is generated by the target apparatus in response to a first control instruction associated with spot check items in a spot check item list, or the feedback information is information inputted on the mobile terminal by an operator.

Practically, as another embodiment of the present disclosure, the first determination result may be a result inputted on the mobile terminal by the operator. The first determination result is actually a spot check result obtained by performing a spot check on the target apparatus.

The first generation module is configured to generate a second control instruction and trigger the first control module 402 in a case that the first determination result indicates that the feedback information meets the requirement.

The second control instruction may be an unlocking instruction.

As another embodiment of the present disclosure, based on the embodiment shown in FIG. 4, the apparatus control device may further include a second data transmission module and a fourth acquisition module.

The second data transmission module is configured to transmit a pre-stored spot check item list of the target apparatus to the mobile terminal in a case that the control information indicates that the user of the target apparatus is authenticated as qualified.

The function of the second data transmission module is similar to the function of the first data transmission module described above, and is not described in detail herein.

The fourth acquisition module is configured to acquire a third control instruction and trigger the first control module in response to the third control instruction.

In a case that the second determination result indicates that the target apparatus meets a spot check requirement, the third control instruction may be generated by the mobile terminal or the server based on the second determination result. The second determination result is determined by the mobile terminal or the server and indicates whether feedback information meets a requirement. The feedback information is generated by the target apparatus in response to a first control instruction associated with spot check items in a spot check item list, or the feedback information is information inputted on the mobile terminal by an operator.

Practically, the third control instruction may be generated by the mobile terminal or the server based on the second determination result inputted on the mobile terminal by the operator, which is not limited herein.

In an actual application of the present embodiment, the third control instruction may be an unlocking instruction obtained in a case that the target apparatus meets the spot check requirement, which is not limited herein.

Furthermore, in a case that the control information indicates that the user of the target apparatus is authenticated as qualified, the apparatus control device may further include a second control module configured to control the target apparatus to be in a standby state.

On the basis of the above embodiments, in a case that a spot check item for which an exception occurs in the spot check process is a preset key item, the apparatus control device may further include:

a first locking module configured to lock the target apparatus.

In a case that a spot check item for which an exception occurs in the spot check process is a preset conventional item, it may be determined by a third determination module of the device whether the number of all of conventional items for which spot check exceptions currently occur reaches a first threshold. If the number reaches the first threshold, the first locking module is triggered.

As another embodiment of the present disclosure, based on the above embodiments, the apparatus control device may further include:

a fifth acquisition module configured to, in a case that an exception occurs during a spot check process performed based on the spot check items in the spot check item list, acquire image information on the spot check exception transmitted by the mobile terminal and transmit the image information on the spot check exception to a server, or transmit a spot check exception instruction to the mobile terminal to control the mobile terminal to transmit acquired image information on the spot check exception to a server.

Optionally, based on the above embodiments, the apparatus control device according to the present disclosure may further include a second generation module and a first interaction module.

The second generation module is configured to generate, in a case that an exception occurs in a spot check process performed based on the spot check items in the spot check item list, an exception item report based on acquired information on all of the spot check exceptions.

During a process of carrying out a spot check on the target apparatus, in addition to generating the exception item report, the report generation module can generate a spot check list based on the acquired spot check information.

The first interaction module is configured to trigger to start a preset information interaction application and publish the exception item report in the information interaction application.

The information interaction application may be a local application installed in the mobile terminal or may be a browser-based information interaction application, which is not specifically limited herein.

It can be seen from the description of the above embodiments that, the controller acquires the control information in a wireless manner and displays the spot check item list of the target apparatus on the mobile terminal in a case that the control information indicates that the user of the target apparatus is authenticated as qualified. In this case, the operator performs a spot check on the target apparatus based on the spot check items in the spot check item list. The selected target apparatus is controlled to be in an unlocked state only in a case that feedback information acquired during the spot check process meets a requirement, thereby improving the safety and reliability in driving the target apparatus. Therefore, in the embodiment, authentication information inputted by users is obtained by the mobile terminal, instead of the existing on-board card reader or on-board display/input terminal, thereby reducing the hardware cost of the apparatus. Besides, the wiring inside the apparatus is simplified, since the mobile terminal is connected to the controller in a wireless manner. Moreover, the visual field of a driver of the apparatus is not blocked, thereby ensuring the safety of the driver and persons around the apparatus and the safety of the goods and equipment around the apparatus

Reference is made to FIG. 6, which is a schematic structural diagram of an apparatus control system according to an embodiment of the present disclosure. The system may include: a server 601, at least one controller 602 and at least one mobile terminal 603.

The mobile terminal 603 is configured to acquire authentication information.

In the present disclosure, the mobile terminal 603 may transmit the authentication information directly to the controller 602 connected to the mobile terminal 603 in a wireless manner as needed, may determine whether the authentication information is qualified and transmit the determination result to the controller 602 connected to the mobile terminal 603 in a wireless manner, or may directly transmit a corresponding control instruction to the controller 602 based on the determination result, which is not limited herein. It should be noted that, the mobile terminal 603 may directly transmit data to the controller 602 or transmit data to the controller via the server 601. For the data transmission manner, one may refer to the description of corresponding parts in the method embodiments and the data transmission manner is not described herein in the embodiment.

In the actual application of the present embodiment, one mobile terminal may correspond to multiple apparatuses (i.e., controllers). Mobile terminals having a one-to-one correspondence with apparatuses to be used at the same time may be arranged for ease of control, to perform daily spot checks, operations and the like on the apparatuses in a wireless way, and unlock the apparatuses in a timely manner in a case that an operation requirement is met.

The controller 402 includes the apparatus control device according to the above device embodiments. Therefore, for the composition and function of the controller, one may refer to the description of the above device embodiments, and they are not described herein in the embodiment of the present disclosure.

Optionally, based on the above embodiments, the system may further include a background management apparatus 604, so that a manager may acquire required information from the server via the Ethernet by using the background management apparatus, such as a working state and a spot check situation of an apparatus, and a working situation of an operator, thereby greatly improving the management efficiency.

Besides, based on the actual requirement, an image acquiring device 605 may be further arranged on an apparatus, to acquire current environment information of the apparatus. Specifically, the image acquiring device 605 may be an on-board shooting system, with which surrounding situations of a forklift truck can be continuously captured in an actual application. In a case that a collision event occurs, videos or a few photos may be acquired as needed within a certain period of time before and after the collision, so that the background management apparatus can restore the collision scene and determine a person responsible for the collision event.

Besides, in addition to the above components, some detection components such as a collision sensor and a position sensor may be provided on the apparatus. For specific functions of the components, one may refer to the corresponding parts of the above method embodiments and the functions are not described herein in the embodiment.

It can be seen from the above analysis that, according to the present disclosure, authentication information of users is acquired by the mobile terminal, instead of the existing on-board card reader or on-board display/input terminal. The authentication information is determined and then a determination result is transmitted to the controller, or the authentication information is directly transmitted to the controller for subsequent determination, or the authentication information is transmitted to the server for subsequent determination and then a determination result is transmitted to the controller. The controller controls the target apparatus to be in an unlocked state only when determining that the control information indicates that the user of the target apparatus is authenticated as qualified, thereby allowing the operator to operate the target apparatus and preventing an unauthorized user from illegally operating the apparatus as well as reducing the hardware cost of the apparatus. Besides, the wiring inside the apparatus is simplified and interference to components other than the controller in the apparatus is reduced, since the mobile terminal is connected to the controller in a wireless manner. Moreover, the visual field of a driver of the apparatus is not blocked, thereby ensuring the safety of the driver and persons around the apparatus and the safety of the goods and equipment around the apparatus.

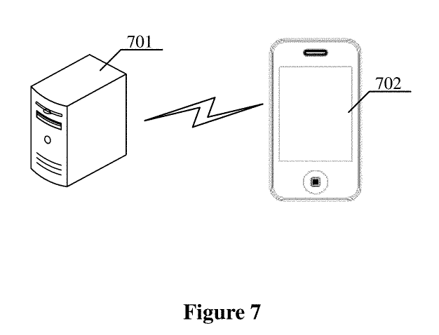

Reference is made to FIG. 7, which is a schematic structural diagram of another apparatus control system according to an embodiment of the present disclosure. The system may include: a server 701 and at least one mobile terminal 702.

The mobile terminal 702 may be connected to the server in a wireless manner, and is configured to acquire identification information of a target apparatus and transmit the identification information to the server 701.

The target apparatus may be a mobile apparatus or a movable industrial apparatus which is provided with an identification code (such as a bar code or a two-dimensional code stuck, and the identification code is not limited thereto) instead of a controller, which is not limited herein.

In an actual application of the present embodiment, the mobile terminal 702 may transmit a scanned identification code of the target apparatus to the server 701, as a working record indicating that a daily spot check is performed on the target apparatus by the operator, so that the system manages the operators.

In addition, in the conventional technology, an employee is assessed by means of swiping a card or inputting authentication information on the on-board display/input terminal. In the present disclosure, the mobile terminal is used, instead of the card reader and the on-board display/input terminal. In this case, an employee is assessed by scanning the identification code of the target apparatus, thereby reducing the hardware cost of the apparatus and simplifying the wiring inside the apparatus. Moreover, the visual field of a driver of the apparatus is not blocked, thereby ensuring the safety of the driver and persons around the apparatus and the safety of the goods and equipment around the apparatus

The mobile terminal may be provided with an image acquisition component such as a camera, to acquire spot check exception information once an exception occurs during a spot check process.

In addition, it should be noted that, in the above embodiments, relationship terms such as “first” and “second” are only used for distinguishing one operation or module from another operation or module, and do not necessarily require or imply that there is an actual relationship or sequence between these modules or operations.

The embodiments of the present disclosure are described in a progressive manner, and each embodiment places emphasis on the difference from other embodiments. Therefore, for the same or similar parts between the embodiments, one may refer to the description of other embodiments. For the device and system according to the embodiments, the device corresponds to the method according to the embodiments, and the system includes the device. Therefore, the description thereof is simple, and for the related parts, one may refer to the description of the method embodiments.

The above description of the embodiments enables those skilled in the art to implement or use the present disclosure. Various modifications to these embodiments are apparent to those skilled in the art, and the general principles defined herein may be implemented in other embodiments without deviating from the spirit or scope of the present disclosure. Therefore, the present disclosure is not limited to these embodiments described herein, but has the widest scope in accordance with the principles and the novel features disclosed herein.

1. An apparatus control method, applied to a controller of an apparatus control system, comprising:
acquiring control information in a wireless manner, wherein the control information comprises: authentication information, a determination result indicating whether the authentication information is qualified and at least one or any combination of control instructions determined based on the determination result indicating whether the authentication information is qualified; and
controlling a target apparatus to be in an unlocked state in a case that the control information indicates that a user of the target apparatus is authenticated as qualified.

2. The method according to claim 1, wherein in a case that the control information indicates that the user of the target apparatus is authenticated as qualified, the method further comprises:
acquiring feedback information, wherein the feedback information is generated by the target apparatus in response to a first control instruction associated with spot check items in a spot check item list, or the feedback information is information inputted on a mobile terminal by an operator;
determining whether the feedback information meets a requirement; and
controlling the target apparatus to be in the unlocked state in a case that the feedback information meets the requirement.

3. The method according to claim 1, wherein in a case that the control information indicates that the user of the target apparatus is authenticated as qualified, the method further comprises:
acquiring a first determination result, wherein the first determination result is determined by a mobile terminal or a server and indicates whether feedback information meets a requirement, the feedback information is generated by the target apparatus in response to a first control instruction associated with spot check items in a spot check item list, or the feedback information is information inputted on the mobile terminal by an operator,
or the first determination result is a result inputted on the mobile terminal by the operator;
generating a second control instruction, in a case that the first determination result indicates that the feedback information meets the requirement; and
controlling the target apparatus to be in the unlocked state in response to the second control instruction.

4. The method according to claim 1, wherein in a case that the control information indicates that the user of the target apparatus is authenticated as qualified, the method further comprises:
acquiring a third control instruction, wherein the third control instruction is generated by a mobile terminal or a server in a case that a second determination result indicates that the target apparatus meets a requirement, the second determination result is determined by the mobile terminal or the server and indicates whether feedback information meets a requirement, the feedback information is generated by the target apparatus in response to a first control instruction associated with spot check items in a spot check item list, or the feedback information is information inputted on the mobile terminal by an operator,
or the third control instruction is generated by a mobile terminal or a server based on a second determination result inputted on the mobile terminal by an operator; and
controlling the target apparatus to be in the unlocked state in response to the third control instruction.

5. The method according to claim 1, wherein the acquiring the control information in a wireless manner comprises:
acquiring, in a wireless manner, authentication information generated and transmitted by a mobile terminal or authentication information generated by the mobile terminal and forwarded by a server;
acquiring, in a wireless manner, a determination result generated and transmitted by the mobile terminal or a determination result generated by the mobile terminal and forwarded by the server;
acquiring, in a wireless manner, a determination result generated and transmitted by the server or a determination result generated by the server and forwarded by the mobile terminal;
acquiring, in a wireless manner, a control instruction generated and transmitted by the mobile terminal or a control instruction generated by the mobile terminal and forwarded by the server; or
acquiring, in a wireless manner, a control instruction generated and transmitted by the server or a control instruction generated by the server and forwarded by the mobile terminal.

6. The method according to claim 5, wherein after the acquiring, in a wireless manner, the authentication information generated and transmitted by the mobile terminal or the authentication information generated by the mobile terminal and forwarded by the server and determining that the authentication information is qualified, the method further comprises:
transmitting a spot check instruction to the mobile terminal, to control the mobile terminal to output a spot check item list of the target apparatus; or
transmitting a spot check instruction to the server, wherein the server controls the mobile terminal to output a spot check item list of the target apparatus.

7. The method according to claim 2, wherein in a case that the control information indicates that the user of the target apparatus is authenticated as qualified, before the acquiring the feedback information, a first determination result or a third control instruction, the method further comprises:
transmitting a spot check item list of the target apparatus to the mobile terminal.

8. The method according to claim 2, wherein in a case that an exception occurs during a spot check process performed based on the spot check items in the spot check item list, the method further comprises:
acquiring image information on a spot check exception acquired by a mobile terminal and transmitting the image information on the spot check exception to a server; or
transmitting a spot check exception instruction to a mobile terminal, to control the mobile terminal to transmit the acquired image information on the spot check exception to a server.

9. The method according to claim 1, wherein in a case that the control information indicates that the user of the target apparatus is authenticated as qualified, the method further comprises: controlling the target apparatus to be in a standby state.

10. The method according to claim 8, wherein
in a case that the spot check item for which the exception occurs during the spot check process is a preset key item, the method further comprises: locking the target apparatus; and
in a case that the spot check item for which the exception occurs during the spot check process is a preset conventional item, the method further comprises: determining whether the number of all of conventional items for which exception currently occurs reaches a first threshold; and locking the target apparatus in a case that the number reaches the first threshold.

11. The method according to claim 8, wherein in a case that the exception occurs in the spot check process performed based on the spot check items in the spot check item list, the method further comprises:
generating an exception item report based on acquired information on all of spot check exceptions; and
triggering to start a preset information interaction application, and publishing the exception item report in the information interaction application.

12. An apparatus control device, comprising:
a first acquisition module configured to acquire control information in a wireless manner, wherein the control information comprises authentication information, a determination result indicating whether the authentication information is qualified and at least one or any combination of control instructions determined based on the determination result indicating whether the authentication information is qualified; and
a first control module configured to control a target apparatus to be in an unlocked state in a case that the control information indicates that a user of the target apparatus is authenticated as qualified.

13. The device according to claim 12, further comprising:
a second acquisition module configured to acquire feedback information in a case that the control information indicates that the user of the target apparatus is authenticated as qualified, wherein the feedback information is generated by the target apparatus in response to a first control instruction associated with spot check items in a spot check item list, or the feedback information is information inputted on a mobile terminal by an operator; and
a first determination module configured to determine whether the feedback information meets a requirement, and trigger the first control module in a case that the feedback information meets the requirement.

14. The device according to claim 12, further comprising:
a third acquisition module configured to acquire a first determination result in a case that the control information indicates that the user of the target apparatus is authenticated as qualified, wherein the first determination result is determined by a mobile terminal or a server and indicates whether feedback information meets a requirement, the feedback information is generated by the target apparatus in response to a first control instruction associated with spot check items in a spot check item list, or the feedback information is information inputted on the mobile terminal by an operator,
or the first determination result is a result inputted on a mobile terminal by an operator; and
a first generation module configured to generate a second control instruction and trigger the first control module in a case that the first determination result indicates that the feedback information meets the requirement.

15. The device according to claim 12, further comprising:
a fourth acquisition module configured to acquire a third control instruction and trigger the first control module in response to the third control instruction;
wherein the third control instruction is generated by a mobile terminal or a server in a case that a second determination result indicates that the target apparatus meets a requirement, the second determination result is determined by the mobile terminal or the server and indicates whether feedback information meets a requirement, the feedback information is generated by the target apparatus in response to a first control instruction associated with spot check items in a spot check item list, or the feedback information is information inputted on the mobile terminal by an operator;
or the third control instruction is generated by a mobile terminal or a server based on a second determination result inputted on the mobile terminal by an operator.

16. The device according to claim 12, wherein in a case that the first acquisition module is configured to acquire, in a wireless manner, authentication information generated and transmitted by a mobile terminal or authentication information generated by a mobile terminal and forwarded by a server, the device further comprises:
a second determination module configured to determine whether the authentication information is qualified; and
a third data transmission module configured to, in a case that the authentication information is determined as qualified by the second determination module, transmit a spot check instruction to the mobile terminal to control the mobile terminal to output a spot check item list of the target apparatus, or transmit a spot check instruction to the server, wherein the server controls the mobile terminal to output a spot check item list of the target apparatus.

17. The device according to claim 13, further comprising:
a fourth data transmission module configured to transmit a spot check item list of the target apparatus to the mobile terminal, in a case that the control information indicates that the user of the target apparatus is authenticated as qualified and before the feedback information, a first determination result or a third control instruction is acquired.

18. The device according to claim 13, further comprising:
a fifth acquisition module configured to, in a case that an exception occurs during a spot check process performed based on the spot check items in the spot check item list, acquire image information on the spot check exception acquired by a mobile terminal and transmit the image information on the spot check exception to a server, or transmit a spot check exception instruction to the mobile terminal to control the mobile terminal to transmit the acquired image information on the spot check exception to a server.

19. The device according to claim 18, further comprising:
a second generation module configured to generate an exception item report based on the acquired information on all of spot check exceptions, in a case that the exception occurs in the spot check process performed based on the spot check items in the spot check item list; and
a first interaction module configured to trigger to start a preset information interaction application and publish the exception item report in the information interaction application.

20. An apparatus control system, comprising: a server, at least one controller and at least one mobile terminal, wherein
the mobile terminal is configured to acquire authentication information; and
the controller comprises the apparatus control device according to claim 12.

21. (canceled)

22. (canceled)
